(19) United States
(12) Patent Application Publication
(10) Pub. No.: US 2017/0244620 A1
(43) Pub. Date: Aug. 24, 2017

(54) High Fidelity Data Reduction for System Dependency Analysis

(71) Applicant: NEC Laboratories America, Inc., Princeton, NJ (US)

(72) Inventors: Zhenyu Wu, Plainsboro, NJ (US); Zhichun Li, Princeton, NJ (US); Jungwhan Rhee, Princeton, NJ (US); Fengyuan Xu, Franklin Park, NJ (US); Guofei Jiang, Princeton, NJ (US); Kangkook Jee, Princeton, NJ (US); Xusheng Xiao, Plainsboro, NJ (US); Zhang Xu, Williamsburg, VA (US)

(21) Appl. No.: 15/416,346

(22) Filed: Jan. 26, 2017

Related U.S. Application Data
(60) Provisional application No. 62/296,646, filed on Feb. 18, 2016.

(51) Int. Cl. H04L 12/26; H04L 29/08

(52) U.S. Cl. CPC H04L 43/08; H04L 67/10

(57) ABSTRACT

Methods and systems for dependency tracking include identifying a hot process that generates bursts of events with interleaved dependencies. Events related to the hot process are aggregated according to a process-centric dependency approximation that ignores dependencies between the events related to the hot process. Causality in a reduced event stream that comprises the aggregated events is tracked.

### RELATED APPLICATION INFORMATION

This application claims priority to U.S. Provisional Application Ser. No. 62/296,646, filed on Feb. 18, 2016, incorporated herein by reference in its entirety. This application is related to an application entitled, “INTRUSION DETECTION USING EFFICIENT SYSTEM DEPENDENCY ANALYSIS,” attorney docket number 15068B, which is incorporated by reference herein in its entirety.

### BACKGROUND

Technical Field

The present invention relates to causality dependency analysis and, more particularly, to data reduction on large volumes of event information.

Description of the Related Art

Accurate causality dependency analysis on computer systems, and particularly forensic dependency analysis, makes use of detailed monitoring and recording of low-level system events, such as process creation, file read/write operations, and network send/receive operations. However, the large volume of information produced by such fine-grained monitoring necessitates significant computing resources to process and store the data in real-time, as well as in selectively accessing the historical information with low latency.

While reducing the volume of data would therefore be advantageous, due to the iterative nature of dependency analysis, the impact of inaccuracies that result from reducing data can be magnified exponentially. For example, a single falsely introduced dependency that is tracked forward or backward several hops along the causality chain could lead to hundreds of false positives.

Some existing techniques for data trace volume reduction make use of, e.g., spatial and temporal sampling. However, due to exponential error amplification in causality dependency analysis, these sampling-based data reduction does not produce useful results. Other techniques operate on highly redundant stack traces, where data reduction can be accomplished through deduplication. However, causality dependencies within collected data do not often have structural duplications that can be easily addressed.

Other attempts have made use of domain knowledge-based pruning, where certain types of files may carry less dependency information than others and, thus, those files can be pruned without introducing significant error. These approaches are of limited general applicability, due to the application-specific nature of the domain knowledge being used.

Finally, some attempts focus on a small set of applications, rather than targeting system-wide dependency analysis. These applications might include, for example, a database or web server. These analyses provide a higher-level view of the collected data that generates less data volume, but at the cost of missing important information that might have been gleaned from the low-level data.

### SUMMARY

A method for dependency tracking includes identifying a hot process that generates bursts of events with interleaved dependencies. Events related to the hot process are aggregated according to a process-centric dependency approximation that ignores dependencies between the events related to the hot process. Causality is tracked in a reduced event stream that includes the aggregated events using a processor.

A system for dependency tracking includes a busy process module configured to identify a hot process that generates bursts of events with interleaved dependencies. An aggregation module is configured to aggregate events related to the hot process according to a process-centric dependency approximation that ignores dependencies between the events related to the hot process. A causality tracking module includes a processor configured to track causality in a reduced event stream that includes the aggregated events.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of a method for data reduction in accordance with the present principles;

FIG. 2 is a block/flow diagram of a method for data reduction in accordance with the present principles;

FIG. 3 is a diagram of an exemplary set of events in accordance with the present principles;

FIG. 4 is a diagram of an exemplary set of events in accordance with the present principles;

FIG. 5 is a block/flow diagram of a method for data reduction in accordance with the present principles;

FIG. 6 is a block diagram of a data reduction system in accordance with the present principles;

FIG. 7 is a block diagram of a processing system in accordance with the present principles; and

FIG. 8 is a block diagram of an intrusion detection system in accordance with the present principles.

### DETAILED DESCRIPTION OF PREFERRED EMBODIMENTS

In accordance with the present principles, systems and methods are provided that reduce system event trace data in real time, while preserving dependencies between events. This increases the scalability of dependency analysis with minimal impact toward the analysis's quality.

To provide data reduction, the present embodiments make a distinction between “key events” and “shadowed events.” In a stream of low-level system events, only a small fraction of events bear causality significance to other events. These events are referred to herein as “key events.” For each key event, there may exist a series of “shadowed events” whose causality relations to other events are negligible in the presence of the key event. That is, the presence or absence of shadowed events does not alter the results of the dependency analysis. The present embodiments therefore detect key events and shadowed events in real-time system event streams. Information relevant to dependency analysis is preserved while data volume is reduced by aggregating and summarizing other information.

The present embodiments can operate in either “lossless” or “lossy” modes. In the lossless mode, data reduction is performed based only on key event and shadowed event identification, so that causality is perfectly preserved. Arbitrary dependency analysis on data before and after data reduction produces the same sequence of events in the same other.

Lossy mode, meanwhile, takes advantage of the fact that some applications (e.g., system daemons) tend to exhibit intense bursts of similar events that are not reducible in lossless mode. One example of such a scenario includes repeatedly accessing a set of files with interleaved dependencies. Each burst generated by such an application may perform a single high-level operation, such as checking for the existence of a particular hardware component, scanning files in a directory, etc. While the high-level operation is not necessarily complex, it can translate to highly repetitive low-level operations. From the perspective of causality analysis, tracking down the high-level operations can yield enough information to aid in understanding the results, such that the details of the exact low-level operation dependencies do not add much more value. Therefore accuracy loss can be acceptable as long as the impact of the errors is contained so as not to affect events that do not belong to the burst.

The present embodiments thereby provide data reduction without impacting the results of causality analysis on low-level system event traces. In addition, the present embodiments may be applied to any type of data, instead of needing domain-specific knowledge that applies only to certain specific types of data. As a result, the present embodiments are applicable to a greater variety of systems. Furthermore, although the present embodiments target low-level system event traces, the present embodiments can be applied at various semantic levels.

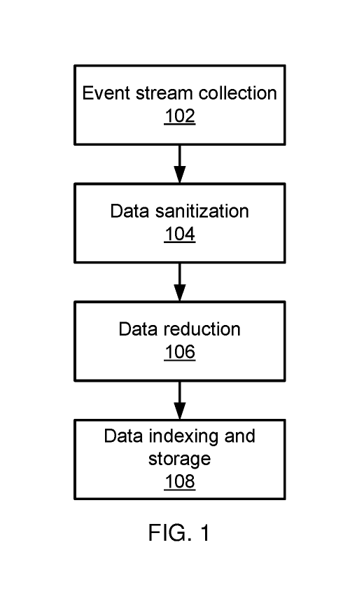

Referring now to FIG. 1, a method for event collection is shown. Block 102 collects an event stream, for example in the form of system calls or other process interactions in a computer system. Although the present embodiments are described with a specific focus on system calls, it should be understood that any variety of event information or other data having dependency relationships may be collected instead. The event stream includes, e.g., timing information, type of operation, and information flow directions, which can be used to reconstruct causal dependencies between historical events. It should be noted that the terms “causality” and “dependency” may be used interchangeably herein. Block 104 performs data sanitization on the collected event stream.

Block 106 performs data reduction on the sanitized event stream. As will be described in greater detail below, data reduction in block 106 may be lossless or lossy, with key events and shadowed events being identified in either case to location categories of event data that may be eliminated. Block 108 then indexes and stores the remaining data for later dependency analysis.

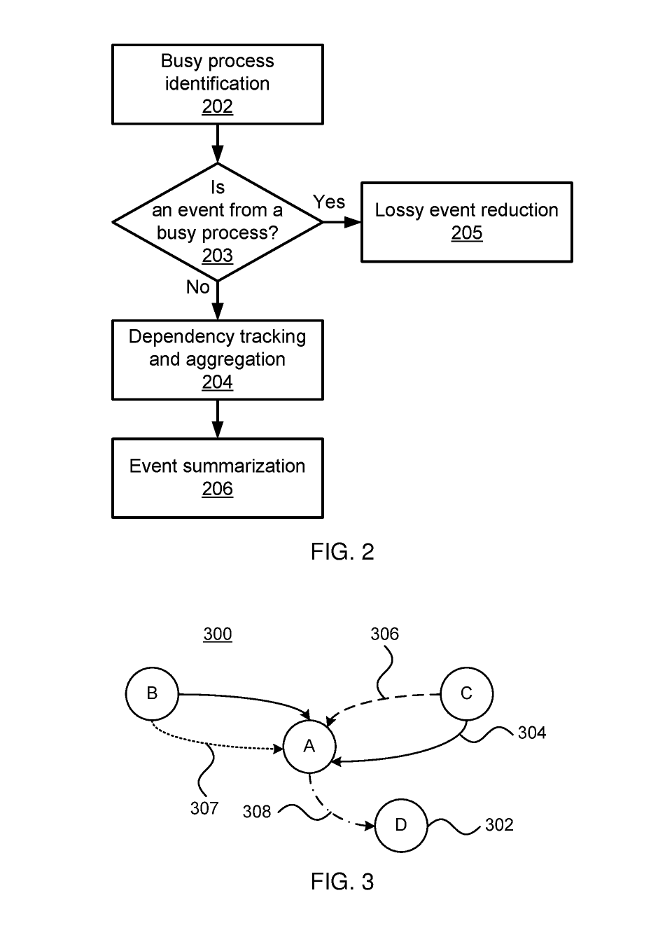

Referring now to FIG. 2, a method for performing data reduction in block 106 is shown. Block 202 identifies busy processes which generate intense bursts of events with interleaved dependencies. Block 02 thereby keeps track of each live process including tracking, e.g., the number of resources (e.g., files, network connections, etc.) that the live processes interact with in a given time interval, and their event intensity. If both metrics are above a predefined threshold, the process is classified as busy, and is referred to herein as a “hot” process. Hot processes can be detected using a statistical calculation with a sliding time window—if the number of events related to a process in a time window exceeds the threshold, the process is marked as a hot process. In one specific example, the threshold may be set to twenty events per five seconds.

Block 203 performs event dispatching, classifying every event according to whether the event belongs to a busy process. Events belonging to busy processes are redirected by block 205 to the process flow of FIG. 5, described below. Block 204 performs dependency tracking and aggregation on the events that do not belong to busy processes. Block 206 performs event summarization, generating a reduced event stream. This method performs lossless data reduction. Another method may be performed alongside the method of FIG. 2 to perform lossy data reduction, handling busy processes that generate events that are not reducible by the lossless method.

The dependency tracking and aggregation of block 204 is used to update temporary events and states, which may be used as feedback for further tracking. Block 204 thereby analyzes and identifies key events that carry causality that is significant in the event stream, as well as corresponding shadowed events, which are candidates for event aggregation.

Referring now to FIG. 3, an example of backtracking event aggregation for a dependency graph 300 is shown. A dependency graph may be used in, e.g., many forensic analysis applications, such as root cause diagnosis, intrusion recovery, attack impact analysis, and forward tracking, which performs causality tracking on the dependency graph 300.

The nodes 302 represent different system entities (e.g., processes or files), while the directed edges between the nodes 302 represent system events between an initiator and a target. The nodes are labeled A, B, C, and D, which may, in one specific example, be considered the entities “/etc/bash,” “/etc/bashrc,” “/etc/inputrc,” and “/bin/wget” respectively. An edge may be described as, e.g., e_{NM-i}, where N represents the initiator node, M represents the target node, and i represents an index for the order of events between those two nodes. Thus, the first recorded event between nodes A and B will be denoted as e_{AB-1}, the second such event will be denoted as e_{AB-2}, and so on. Each event is described in this example as an event type and a time window during which the event takes place. Thus, an event e_{AB-1} may be described as a “Read” event occurring in the time window between timestamp 10 and timestamp 20: [10, 20]. In this manner, the nodes and edges encode information needed for causality analysis: the information flow direction (reflected by the direction of the edge), the type of event, and the window during which the event takes place.

Causality tracking is a recursive graph traversal procedure, which follows the causal relationship of edges either in the forward or backward direction. For example, in FIG. 3, to examine the root cause of event e_{AD-1}, backtracking is applied on this edge, which recursively follows all edges that could have contributed to e_{AD-1}. Causality dependency may be formally defined for two events e_{gh} and eᵢⱼ if node h is the same as node I and if the end time for e_{gh} is before the end time for eᵢⱼ. If e_{gh} has information flow to eᵢⱼ, and eᵢⱼ has information flow to a third event eₘₙ, then eᵢⱼ has information flow to eₘₙ.

Given two event edges across the same pair of nodes eᵢⱼ₋₁ and eᵢⱼ₋₂, where the ending time of eᵢⱼ₋₂ is later than the ending time of eᵢⱼ₋₁, eᵢⱼ₋₂ shadows the backward causality of eᵢⱼ₋₁ if and only if there exists no event edge eₘₙ that satisfies all of i=m, j≠n, the ending time of eₘₙ being later than that of eᵢⱼ₋₁, and the ending time of eₘₙ being before the ending time of eᵢⱼ₋₂. Similarly, eᵢⱼ₋₁ shadows the forward causality of eᵢⱼ₋₂ if and only if there exists no event edge eₘₙ that satisfies all of i≠m, j=n, the ending time of eₘₙbeing later than the ending time of eᵢⱼ₋₁, and the ending time of eₘₙ being before the ending time of eᵢⱼ₋₂. Two event edges are then fully equivalent in trackability if and only if eᵢⱼ₋₂ backward-shadows eᵢⱼ₋₁ and eᵢⱼ₋₁ forward-shadows eᵢⱼ₋₂.

Two events are aggregable only if they have the same type and share the same source and destination nodes. For certain types of events, such as read/write, the two events also may need to share certain attributes (e.g., a file open descriptor). A set of aggregable events is a superset of a key event and its shadowed events.

Following the present example, there are two reads of the file /etc/bashrc (node B), two reads of the file /etc/inputrc (node C), and one execution of /bin/wget (node D), all performed by the process /bin/bash (node A). The arrows indicate the flow of information, from the read files to /bin/bash, and from /bin/bash to the executed /bin/wget. If causality analysis is employed to determine the cause of the event e_{AD-1}, the events that cause information flow into the node A prior to event e_{AD-1} are backtracked, including events e_{AB-1} (read, [10, 20]), e_{AC-1} (read, [15, 23]), and e_{AC-2} (read, [28, 32]). In this example, event e_{AB-2} (read, [40, 42]) occurs after the event of interest 308 e_{AD-1} (exec, [36, 37]). As a result, the existence of e_{AB-2} has no causality impact to the causality of e_{AD-1}. The irrelevant event is marked with a dotted line 307

The second event between A and C, e_{AC-2}, takes place after e_{AC-1} and both events are of the same type (read) involving the same entities. As a result, the existence of e_{AC-1} in the event stream has no causality impact on the backward dependency of e_{AD-1}. In other words, e_{AC-2} is a key event 304 that shadows the event e_{AC-1}, with shadowed events being denoted by dashed line 306. In an attack forensic analysis example, the shadowed events describe the same event attacker activities that have already been revealed by the key events. Therefore, the data volume can be reduced by keeping the causal dependencies intact by, e.g., merging or summarizing information in “shadowed events” into “key events” while preserving causal relevant information in the latter.

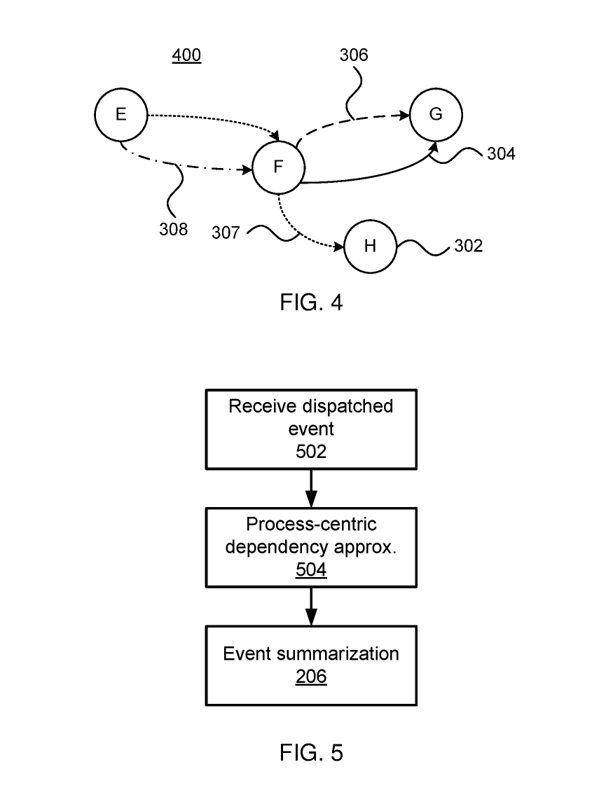

Referring now to FIG. 4, an example of forward-tracking event aggregation for a dependency graph 400 is shown. In this example, aggregable events are identified for forward-tracking. Node E may be, for example, “excel.exe,” node F may be, “salary.xls,” node G may be, “dropbox.exe,” and node H may be, “backup.exe,” and events may include e_{EF-1} (write, [10, 20]), e_{EF-1} (write, [30, 32]), e_{FG-1} (read, [42, 44]), e_{FG-2} (read, [38, 40]), and e_{FH-1} (read [18, 27]).

In this example, the event of interest 308 is event e_{EF-2}, with a time window of [30, 32]. The events e_{EF-1} and e_{FH-1} both occur before e_{EF-2}, so they are marked as irrelevant events 307 for forward-tracking. Event e_{FG-2} occurs before e_{FG-1}, making e_{FG-2} a key event 304 and e_{FG-1} a shadowed event 306.

Block 206 is responsible for performing data reduction. Given a key event 304 and its associated shadowed events 306, block 206 merges all events' time windows into a single time window which tightly encapsulates the start and end of the entire set of events. In addition, event type-specific data summarization is performed on other attributes of the events. For example, for “read” events, the amount of data read in all events may be accumulated into a single number denoting the total amount of data read by the set.

Thus, if three events between nodes X and Y exist (e_{XY-1} (write, [10, 20], 20 bytes), e_{XY-2} (read, [18, 27], 50 bytes), and e_{XY-3} (write, [30, 32], 200 bytes)), the key event may be identified as e_{XY-3}, with e_{XY-1} and e_{XY-2} being identified as shadowed events. The events may then be reduced to a single event E_{XY-1} (write, [10, 32], 270 bytes).

Referring now to FIG. 5, a secondary process for performing data reduction in block 106 is shown. This secondary workflow may be performed in addition to and in parallel with the process of FIG. 2. As noted above, block 202 detects busy processes and block 205 dispatches the busy processes. Block 502 receives the dispatched, hot process and collects all objects involved in the interactions to form a neighbor set N(u), where u is the hot process. Instead of checking he trackability of all aggregation candidates, only those events with information flow into and out of the neighbor set N(u) are checked. This ensures that, as long as no event inside N(u) is selected as an event-of-interest, high-quality tracking results are generated.

Based on the events for the busy processes, block 504 performs dependency approximating data reduction. In one example, a busy process may be scanning files. The process and its directed interactions with other system objects may be tracked. All of these events may be considered part of a single high-level operation. As a result, the exact causalities among the events can be ignored and the events may aggregated, even if they would not otherwise be aggregable. Block 206 then aggregates events as indicated by block 504. The aggregated events that result from FIG. 5 may introduce some accuracy loss, but this accuracy loss is well-contained to events generated by busy processes.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

One particular application for the present embodiments is in the field of detecting advanced persistent threat (APT) attacks, which may include intrusive, multi-step attacks. It can take a significant amount of time for an attacker to gradually penetrate into an enterprise's computer systems, to understand its infrastructure, and to steal important information or to sabotage important infrastructure. Compared with conventional attacks, sophisticated, multi-step attacks such as APT attacks can inflict much more severe damage upon an enterprise's business. To counter these attacks, enterprises would benefit from solutions that “connect the dots” across multiple activities that, individually, might not be suspicious enough to raise an alarm. Because an attacker might potentially attack any device within the enterprise, attack provenance information is monitored from every host.

In one study, APT attacks were found to have remained undiscovered for an average of about 6 months, and in some cases years, before launching harmful actions. This implies that, to detect and understand the impact of such attacks, enterprises need to store at least half a year of event data. The system-level audit data alone can easily reach 1 Gb per host. In a real-world scenario of an enterprise with 200,000 hosts, the data storage is around 17 petabytes to around 70 petabytes.

The data not only needs to be stored efficiently, but indexed to make retrieval efficient. The present embodiments provide the ability to aggregate event information without substantially affecting the accuracy of the ability to detect attacks.

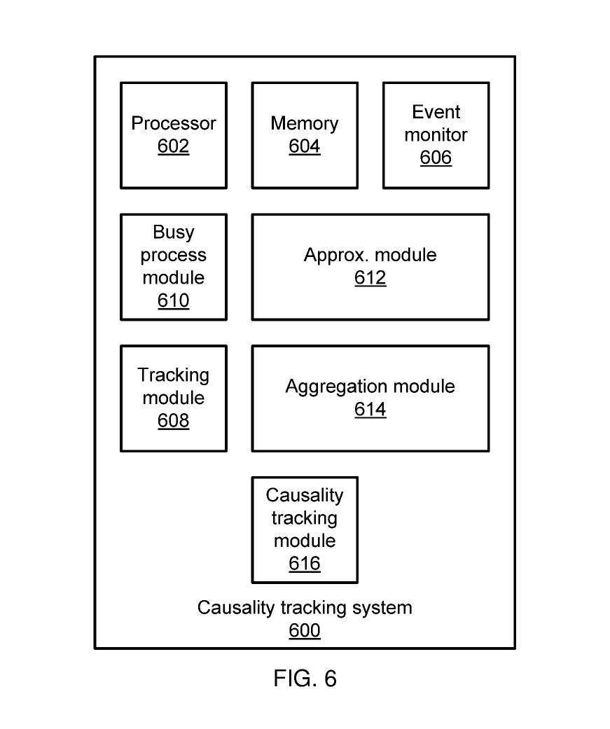

Referring now to FIG. 6, a system 600 for dependency tracking is shown. The system 600 includes a hardware processor 602 and a memory. The system 600 also includes one or more functional modules that may, in one embodiment, be implemented as hardware that is stored by the memory 604 and executed by the processor 602. In an alternative embodiment, the functional modules may be implemented as one or more discrete hardware components, for example in the form of an application-specific integrated chip or field programmable gate array.

The functional modules include, e.g., an event monitor 606 that tracks high-level and low-level events and generates an event stream. A tracking module 608 identifies key events in the event stream as well as corresponding shadowed events. A busy process module 610 identifies hot processes within the event stream, while an approximation module 612 determines aggregations of the events related to the hot processes. An aggregation module 614 aggregates events in accordance with the output of the tracking module and the approximation module 612. A causality tracking module 616 then performs causality tracking for an event-of-interest, using the event stream and event aggregations.

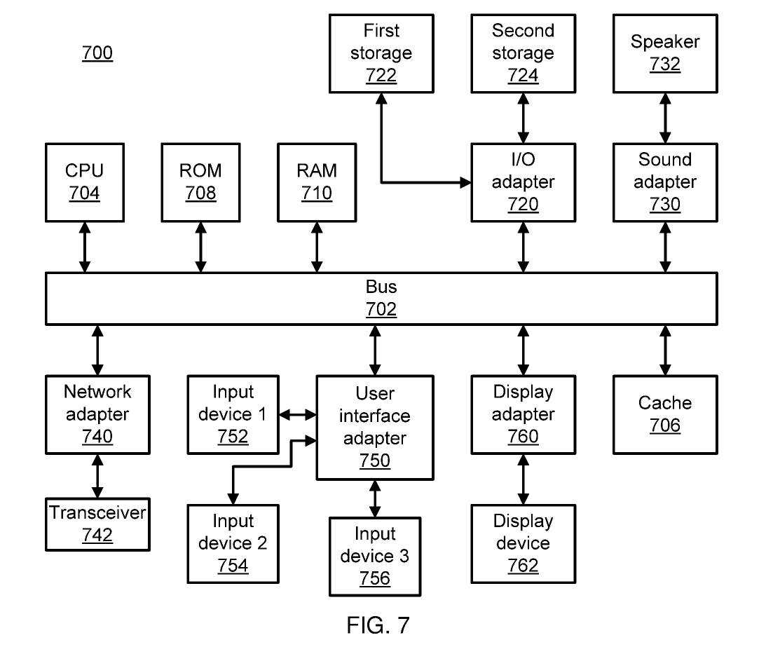

Referring now to FIG. 7, an exemplary processing system 700 is shown which may represent the transmitting device 100 or the receiving device 120. The processing system 700 includes at least one processor (CPU) 704 operatively coupled to other components via a system bus 702. A cache 706, a Read Only Memory (ROM) 708, a Random Access Memory (RAM) 710, an input/output (I/O) adapter 720, a sound adapter 730, a network adapter 740, a user interface adapter 750, and a display adapter 760, are operatively coupled to the system bus 702.

A first storage device 722 and a second storage device 724 are operatively coupled to system bus 702 by the I/O adapter 720. The storage devices 722 and 724 can be any of a disk storage device (e.g., a magnetic or optical disk storage device), a solid state magnetic device, and so forth. The storage devices 722 and 724 can be the same type of storage device or different types of storage devices.

A speaker 732 is operatively coupled to system bus 702 by the sound adapter 730. A transceiver 742 is operatively coupled to system bus 702 by network adapter 740. A display device 762 is operatively coupled to system bus 702 by display adapter 760.

A first user input device 752, a second user input device 754, and a third user input device 756 are operatively coupled to system bus 702 by user interface adapter 750. The user input devices 752, 754, and 756 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 752, 754, and 756 can be the same type of user input device or different types of user input devices. The user input devices 752, 754, and 756 are used to input and output information to and from system 700.

Of course, the processing system 700 may also include other elements (not shown), as readily contemplated by one of skill in the art, as well as omit certain elements. For example, various other input devices and/or output devices can be included in processing system 700, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 700 are readily contemplated by one of ordinary skill in the art given the teachings of the present principles provided herein.

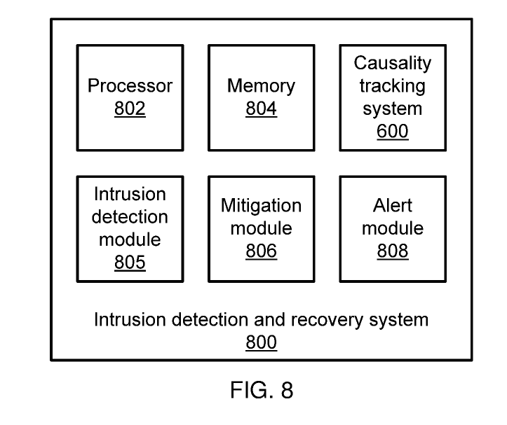

Referring now to FIG. 8, an intrusion detection and recovery system 300 is shown. The intrusion detection system 300 includes a causality tracking system 600 as described above. The intrusion detection and recovery system 800 may be tightly integrated with the causality tracking system 600, using the same hardware processor 602 and memory 604, or may alternatively have its own standalone hardware processor 802 and memory 804. In the latter case, the intrusion detection and recovery system 800 may communicate with the causality tracking system by, for example, inter-process communications, network communications, or any other appropriate medium and/or protocol.

The intrusion detection and recovery system 800 may flag particular events for review. This may performed automatically, for example using one or more heuristics or machine learning processes to determine when an event is unexpected or otherwise out of place. Flagging events for review may alternatively, or in addition, be performed by a human operator who selects specific events for review. The intrusion detection and recovery system 800 then indicates the flagged event to the causality tracking system 600 to efficiently build a causality trace for the flagged event. Using this causality trace, an intrusion detection module 805 determines whether an intrusion has occurred. The intrusion detection module 805 may operate using, e.g., one or more heuristics or machine learning processes that take advantage of the causality information provided by the causality tracking system 600 and may be supplemented by review by a human operator to determine that an intrusion has occurred.

When intrusion has been detected, a mitigation module 806 may automatically trigger one or more mitigation actions. Mitigation actions may include, for example, changing access permissions in one or more affected or accessible computing systems, quarantining affected data or programs, increasing logging or monitoring activity, and any other automatic action that may serve to stop or diminish the effect or scope of an intrusion. Mitigation module 806 can guide mitigation and recovery by forward-tracking the impact of an intrusion using the causality trace. An alert module 808 may alert a human operator of the intrusion, providing causality information as well as information regarding any mitigation actions that have occurred.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for dependency tracking, comprising:
identifying a hot process that generates bursts of events with interleaved dependencies;
aggregating events related to the hot process according to a process-centric dependency approximation that ignores dependencies between the events related to the hot process; and
tracking causality in a reduced event stream that comprises the aggregated events using a processor.

2. The method of claim 1, wherein identifying the hot process comprises counting a number of events generated by a process over a period of time.

3. The method of claim 2, wherein identifying the hot process comprises comparing the counted number of events to a threshold, such that a process having a counted number of events in the period of time that exceeds the threshold is identified as a hot process.

4. The method of claim 1, wherein aggregating events related to the hot process comprises replacing said events by a single event that has a duration that includes all of the durations of said events.

5. The method of claim 1, further comprising:
identifying key events and corresponding shadowed events; and
aggregating shadowed events with respective key events.

6. The method of claim 5, wherein an output of causality tracking is not affected by the presence or absence of shadowed events.

7. The method of claim 5, wherein identifying key events comprises identifying key events in a backward-tracking scenario.

8. The method of claim 5, wherein identifying key events comprises identifying key events in a forward-tracking scenario.

9. The method of claim 5, wherein identifying key events and shadowed events and aggregating shadowed events are performed only for events that are not associated with a hot process.

10. A system for dependency tracking, comprising:
a busy process module configured to identify a hot process that generates bursts of events with interleaved dependencies;
an aggregation module configured to aggregate events related to the hot process according to a process-centric dependency approximation that ignores dependencies between the events related to the hot process; and p1 a causality tracking module comprising a processor configured to track causality in a reduced event stream that comprises the aggregated events.

11. The system of claim 10, wherein the busy process module is further configured to count a number of events generated by a process over a period of time.

12. The system of claim 11, wherein the busy process module is further configured to compare the counted number of events to a threshold, such that a process having a counted number of events in the period of time that exceeds the threshold is identified as a hot process.

13. The system of claim 10, wherein the aggregation module is further configured to replace events by a single event that has a duration that includes all of the durations of the replaced events.

14. The system of claim 10, further comprising a tracking module configured to identify key events and corresponding shadowed events, wherein the aggregation module is further configured to aggregate shadowed events with respective key events.

15. The system of claim 14, wherein an output of the tracking module is not affected by the presence or absence of shadowed events.

16. The system of claim 14, wherein the tracking module is further configured to identify key events in a backward-tracking scenario.

17. The system of claim 14, wherein the tracking module is further configured to identify key events in a forward-tracking scenario.

18. The system of claim 14, wherein the tracking module is further configured to identify key events and shadowed events and aggregate shadowed events are performed only for events that are not associated with a hot process
